(19) United States
(12) Patent Application Publication
(10) Pub. No.: US 2023/0222843 A1
(43) Pub. Date: Jul. 13, 2023

(54) METHOD AND DEVICE FOR REGISTERING BIOMETRIC FEATURE

(71) Applicant: BEIJING XIAOMI MOBILE SOFTWARE CO., LTD., Beijing (CN)

(72) Inventors: Yajun ZHU, Beijing (CN); Lei YU, Beijing (CN)

(73) Assignee: BEIJING XIAOMI MOBILE SOFTWARE CO., LTD., Beijing (CN)

(21) Appl. No.: 18/009,700

(22) PCT Filed: Jun. 10, 2020
(86) PCT No.: PCT/CN2020/095458

§ 371 Date: Dec. 9, 2022

(51) Int. Cl. G06V 40/50; G06F 21/32; G06F 21/60

(52) U.S. Cl. CPC G06V 40/53; G06F 21/32; G06F 21/602

(57) ABSTRACT

Provided is a biological feature registration method. The method includes: performing privacy removal process on a first biological feature of a biological sample to obtain a second biological feature, where the second biological feature is a biological sample feature used for performing identity authentication.

### CROSS-REFERENCE TO RELATED APPLICATIONS

The present application is the U.S. National Stage of International Application No. PCT/CN2020/095458 filed on Jun. 10, 2020, the entire contents of which are incorporated herein by reference for all purposes.

### TECHNICAL FIELD

The present disclosure relates to the technology field of wireless communication but is not limited thereto, and in particular, to a method and device for registering a biometric feature, a communication device and a storage medium.

### BACKGROUND

As in current society, there is a high demand for accuracy and reliability in public security and identity identification, the traditional identification method such as password and magnetic card is no longer sufficient to meet the needs of society due to being easily embezzled and forged. Biometric features such as fingerprint, face, iris, vein, voiceprint and behavior are playing an increasingly important role in identity authentication and are receiving more and more attention because of their uniqueness (i.e., the features of any two people shall be different), robustness (i.e., the feature does not change over time), collectability (i.e., the feature can be collected quantitatively), high trustworthiness and high accuracy. However, in the application of biometric feature, the biometric feature may be stolen which raises security issue.

### SUMMARY

A first aspect of the present disclosure discloses a method for registering a biometric feature, including: performing a privacy-removing process on a first biometric feature of a biological sample to obtain a second biometric feature, where the second biometric feature is a biological sample feature for identity authentication.

A second aspect of the present disclosure provides a device for registering a biometric feature, including a processor and a memory for storing executable instructions of the processor, where when running the executable instructions, the processor is configured to implement acts comprising performing a privacy-removing process on a first biometric feature of a biological sample to obtain a second biometric feature, where the second biometric feature is a biological sample feature for identity authentication.

A third aspect of the present disclosure provides a non-transitory computer storage medium having a computer executable program stored thereon that, when being executed by the processor, implements acts comprising performing a privacy-removing process on a first biometric feature of a biological sample to obtain a second biometric feature, where the second biometric feature is a biological sample feature for identity authentication.

### BRIEF DESCRIPTION OF THE DRAWINGS

FIG. 1 is a structure schematic diagram of a wireless communication system.

FIG. 2 is a schematic diagram of a biometric feature according to an embodiment.

FIG. 3 is a flowchart of a method for registering a biometric feature according to an embodiment.

FIG. 4 is a flowchart of a method for registering a biometric feature according to an embodiment.

FIG. 5 is a schematic diagram of a biometric feature processing according to an embodiment.

FIG. 6 is a schematic diagram of a biometric feature processing according to an embodiment.

FIG. 7 is a schematic diagram of a biometric feature processing according to an embodiment.

FIG. 8 is a flow diagram of a biometric feature process according to an embodiment.

FIG. 9 is a flow diagram of a method for registering a biometric feature according to an embodiment.

FIG. 10 is a flow diagram of a method for registering a biometric feature according to an embodiment.

FIG. 11 is a flow diagram of a method for registering a biometric feature according to an embodiment.

FIG. 12 is a flow diagram of a method for registering a biometric feature according to an embodiment.

FIG. 13 is a schematic diagram of a device for registering a biometric feature according to an embodiment.

FIG. 14 is a block diagram of a user device according to an embodiment.

FIG. 15 is a block diagram of a base station according to an embodiment.

### DETAILED DESCRIPTION

Embodiments will be described in detail herein, examples of which are illustrated in the accompanying drawings. When the following description is made with reference to the drawings, the same numerals in different drawings refer to the same or similar elements unless otherwise indicated. The implementations described in the embodiments below are not intended to represent all implementations of the embodiments of the present disclosure. Rather, they are merely examples of devices and methods according to some aspects of the embodiments of the present disclosure as recited in the appended claims.

The terminology used in the embodiments of the present disclosure is for the purpose of describing particular embodiments only and is not intended to limit the embodiments of the present disclosure. As used in the embodiments of the present disclosure and the appended claims, the singular forms “a,” “an” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third and the like may be used in the embodiments of the present disclosure to describe various pieces of information, such information should not be limited by these terms. These terms are only used to distinguish the same type of information from each other. For example, first information may also be referred to as second information, and similarly, the second information may also be referred to as the first information, without departing from the scope of the embodiments of the present disclosure. Depending on the context, the word “if” as used herein may be interpreted as “at the time of” or “when” or “in response to determining.”

For the sake of brevity and ease of understanding, the terms “greater than” or “less than” are used herein to indicate a size relationship. However, it will be understood by those skilled in the art that the term “greater than” also covers the meaning of “greater than or equal to” and the term “less than” also covers the meaning of “less than or equal to.”

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

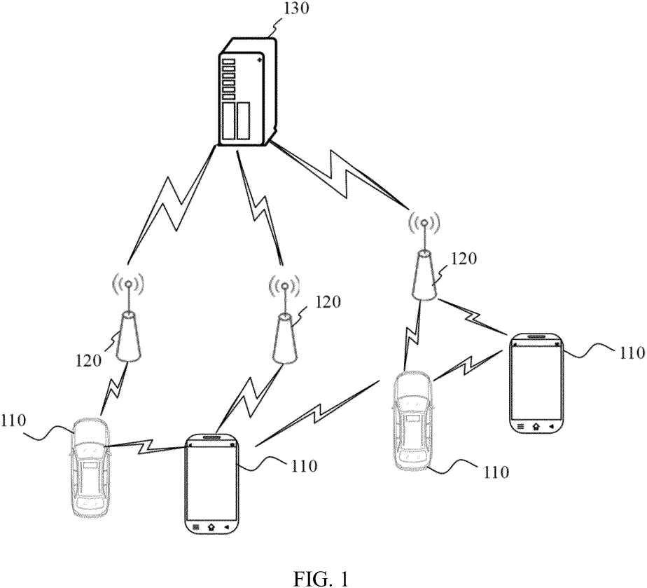

FIG. 1 shows a schematic structural diagram of a wireless communication system according to an embodiment of the present disclosure. As shown in FIG. 1, the wireless communication system is a communication system based on cellular mobile communication technology, and may include a plurality of user devices 110 and a plurality of base stations 120.

The user device 110 may be a device that provides voice and/or data connectivity to a user. The user device 110 may communicate with one or more core networks via radio access network (RAN). The user device 110 may be an IoT user device such as a sensor device, a mobile phone (or “cellular” phone), and may be a computer having the IoT user device, which, for example, may be a stationary, portable, pocket-sized, hand-held, computer-built-in, or vehicle-mounted device. For example, the user device 110 may be a station (STA), subscriber unit, subscriber station, mobile station, mobile, remote station, access point, remote terminal, access terminal, user terminal, user agent, user device, or user equipment (UE). Alternatively, the user device 110 may also be a device of an unmanned aerial vehicle. Alternatively, the user device 110 may also be an in-vehicle device, for example, a trip computer with a wireless communication function, or a wireless user device connected to an external trip computer. Alternatively, the user device 110 may also be a roadside device, for example, may be a streetlight, a signal light, or other roadside device having a wireless communication function.

The base station 120 may be a network-side device in a wireless communication system. The wireless communication system may be a 4th generation mobile communication (4G) system, also known as a long term evolution (LTE) system. Alternatively, the wireless communication system may be a 5G system, also known as a new radio (NR) system or a 5G NR system. Alternatively, the wireless communication system may be a next-generation system of the 5G system. The access network in the 5G system may be called NG-RAN (New Generation-Radio Access Network).

The base station 120 may be an evolved base station (eNB) employed in the 4G system. Alternatively, the base station 120 may be a base station (gNB) that adopts a centralized distributed architecture in the 5G system. When adopting the centralized distributed architecture, the base station 12 usually includes a central unit (CU) and at least two distributed units (DUs). The central unit is provided with a protocol stack of a packet data convergence protocol (PDCP) layer, a radio link control (RLC) layer, and a medium access control (MAC) layer. The distributed unit is provided with a physical (PHY) layer protocol stack. The specific implementation manner of the base station 120 is not limited in the embodiments of the present disclosure.

A wireless connection may be established between the base station 120 and the user device 110 through a wireless radio. In different embodiments, the wireless radio is a wireless radio based on the fourth generation mobile communication network technology (4G) standard; or the wireless radio is a wireless radio based on the fifth generation mobile communication network technology (5G) standard, for example, the wireless radio is a new radio; or, the wireless radio may also be a wireless radio of a 5G-based next generation mobile communication network technology standard.

In some embodiments, an E2E (end-to-end) connection may also be established between the user device0 110, for example, in scenarios such as V2V (vehicle to vehicle) communication, V2I (vehicle to infrastructure) communication and V2P (vehicle to pedestrian) communication in vehicle to everything (V2X) communication.

Herein, the above user device may be the terminal device in the following embodiments.

In some embodiments, the above wireless communication system may further include a network management device 130.

The plurality of base stations 120 are respectively connected to the network management device 130. The network management device 130 may be a core network device in the wireless communication system, for example, the network management device 13 may be a mobility management entity (MME) in an evolved packet core network (EPC). Alternatively, the network management device may also be other core network devices, such as a serving gateway (SGW), public data network gateway (PGW), policy and charging rules function unit (PCRF), home subscriber server (HSS) or the like. The implementation of the network management device 130 is not limited in the embodiments of the present disclosure.

To facilitate the understanding of any embodiment of the present disclosure, a biometric feature identification technology is described firstly.

The biometric feature identification technology refers to the process of extracting an individual physiological feature or a personal behavior characteristic for the purpose of identity identification by using an automatic technique and comparing these characteristics or features with template data already available in a database, thereby completing the identity authentication. In theory, all physiological features and personal behavior characteristics having universality, uniqueness, robustness and collectability are collectively referred to as biometric features. Unlike traditional identification methods, the biometric feature identification utilizes the individual characteristics of humans for identity authentication. A generic biometric feature identification system shall contain sub-systems for data collecting, data storing, comparing and decision making.

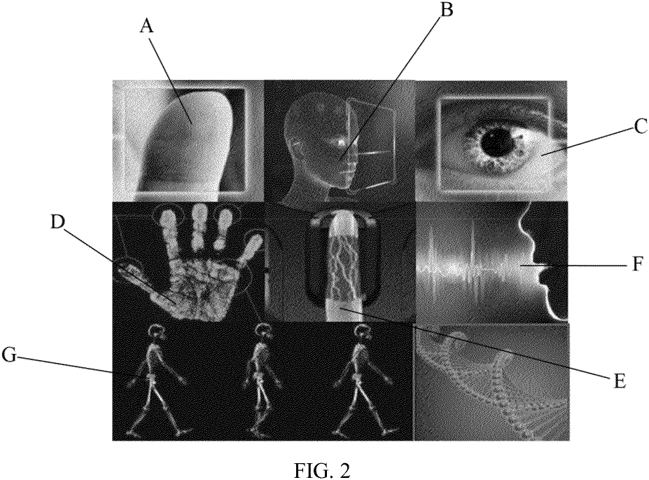

The biometric feature identification technology involves a wide range of contents, as shown in FIG. 2. The biometric feature identification includes a variety of identification methods such as fingerprint A, face B, iris C, palm print D, vein E, voice print F, gesture G, and the identification process thereof involves a number of technologies such as data collecting, data processing, graphic image identification, comparing algorithm and software design. At present, various software and hardware products and industry application solutions based on the biometric feature identification technology are widely used in finance, human society, public security, education and other fields.

There are certain risks involved in the use of biometric feature identification. During the two processes of biometric feature registration and identity authentication, the biometric feature identification system is in a state of interaction with the outside world, and the system is very vulnerable to an external attack at this time. In the biometric feature registration process, the security of the system is vulnerable to the following threats.

1. Falsifying identity: the attacker uses a falsified identity (e.g., a false identity document or identification material) to apply for registration with the system and passes the identity audit, which creates a falsified correspondence between the biometric feature and the identity in the biometric feature template database.

2. Falsifying feature: the attacker provides a false biometric feature when the system collects the biometric feature sample.

3. Tampering with feature processor: the attacker attacks the system when the system extracts and processes the biometric feature, thereby forming a false sample through registration in the biometric feature template database.

4. Transmitting attack: the attacker carries out an attack during data transmission from the biometric feature collection subsystem to the biometric feature template database, which allows the acquisition of biometric feature information of registered users on the one hand and the registration of false and falsified biometric feature information in the biometric template database on the other hand.

5. Hacking into database and attacking: the attacker can hack into the system’s biometric feature template database and tamper and forge the registered biometric feature information through hacking means.

The wide use of biometric feature leads to a hidden dangerous of personal privacy and security. If the biometric feature information stored in the system is leaked or lost, it may easily be used to impersonate the user in any system that uses the biometric feature information as authentication information, thus posing a significant risk to the user’s privacy and account security.

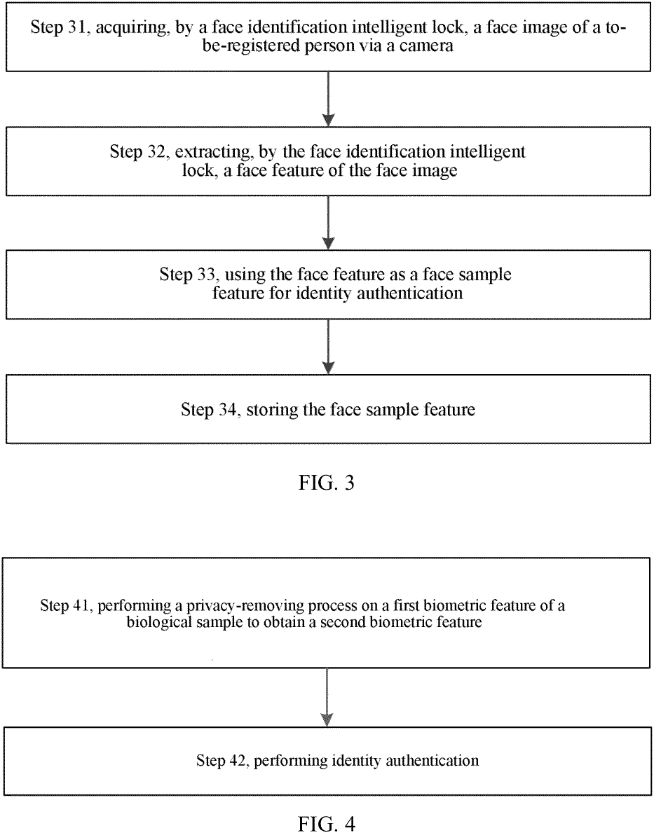

Next, the process for registering a biometric feature is illustrated by taking a face identification intelligent lock which is widely used as an example. Referring to FIG. 3, the method for registering a face in a face identification intelligent lock provided by an embodiment of the present disclosure includes the following steps.

In step 31, the face identification intelligent lock acquires a face image of a to-be-registered person via a camera.

In step 32, the face identification intelligent lock extracts a face feature of the face image.

In step 33, the face feature is used as a face sample feature for identity authentication.

In step 34, the face sample feature is stored.

In an embodiment, when the face to be verified needs to be authenticated, the face sample feature is compared with the face feature to be verified. When the similarity of the face feature determined by the comparison is greater than a set threshold, the verification is successful; and when the similarity of the face feature determined by the comparison is less than the set threshold, the verification fails.

FIG. 4 illustrates a method for registering a biometric feature according to an embodiment, and the method includes:

step 41, performing a privacy-removing process on a first biometric feature of a biological sample to obtain a second biometric feature.

The second biometric feature is a biological sample feature for identity authentication.

In the embodiment of the present disclosure, the first biometric feature of the biological sample is de-privatized to obtain the second biometric feature and the second biometric feature is the biometric sample feature for identity authentication. Here, since the biometric sample feature for identity authentication is the second biometric feature obtained by de-privatizing the first biometric feature of the biometric sample, even if the second biometric feature is stolen during a registration process or after being stored, the second biometric feature cannot be restored or reverted to the first biometric feature, thereby enhancing the security of the biometric feature during or after the registration process.

The method for registering the biometric feature is applied to a terminal or a server. The terminal may be but is not limited to a mobile phone, a wearable device, a vehicle terminal, a road side unit (RSU), a smart home terminal, an industrial sensing device and/or a medical device, etc.

The server may be a variety of application servers or communication servers.

For example, the application server may be a server that provides application services for an application provider. The communication server may be a server that provides communication services for a communication operator.

In an embodiment, after the user completes a biometric feature registration on the terminal and/or server, and logs in by using the registered biometric feature, the user can use the application or function on the terminal or server. For example, a payment application is installed on a mobile phone. Before the user can use the payment application, the mobile phone needs to obtain the user’s face feature and determines the face feature as the biometric sample feature used when the user logs in the payment application for identity authentication. The user can use the payment application installed on the mobile phone after the identity authentication using the face feature is successful.

For another example, the server has a permission management software installed thereon. Before the user can use the permission management software, the server needs to obtain the fingerprint feature of the user, and determines the fingerprint feature as the biometric sample feature used when the user logs into the permission management software for identity authentication. The user can use the permission management software installed on the server after the identity authentication using the fingerprint feature is successful.

Here, the process of identity authentication may be performed on the server or on the mobile phone. In an embodiment, the process of identity authentication is performed on the authentication server. During registration the mobile phone may send the biometric sample feature acquired for identity authentication to the authentication server. The mobile phone may also send the acquired face feature to be detected to the authentication server during identity authentication, and the authentication server performs a similarity comparison on the biometric sample feature for identity authentication and the face feature to be detected, obtains the authentication result, and provides the authentication result back to the mobile phone.

In an embodiment, the biometric feature may be represented by a feature value. For example, the biometric feature may be characterized by using a feature vector, and each feature vector may include a plurality of feature values. For example, the biometric feature is a human gesture feature, the feature vector used to characterize the gesture feature may be A={a, b, c, d}, where a, b, c, d are the feature values of the human gesture feature. Here, different biometric features have different feature vectors. The similarity between different biometric features may be obtained by calculating the Euclidean distance corresponding to feature vectors of two biometric features.

For example, if the feature vector of a biometric feature M is M= {m1, m2, m3, m4} and the feature vector of a biometric feature N is N={n1, n2, n3, n4}, the similarity between the biometric feature M and the biometric feature N may be expressed as

$$\text{S} = \sqrt{{\left(m 1 - n 1\right)}^{2} + {\left(m 2 - n 2\right)}^{2} {\left(m 3 - n 3\right)}^{2} + {\left(m 4 - n 4\right)}^{2}} .$$

In some embodiments, the first biometric feature may include a body surface feature of a living body such as fingerprint, iris, vein feature and/or face feature, and a feature of biological tissue such as muscle, bone or skin in the body.

In other embodiments, the first biometric feature may be a feature which is determined by a user’s limb but is not the user’s limb itself, such as a trajectory feature of swinging hand, a feature of lowering or rising head.

In some embodiments, the first biometric feature may also be a combination of two or more of features such as fingerprint, face, iris, vein, voice print and gesture. For example, the first biometric feature may be a combination of a face feature and an iris feature.

The first biometric feature is obtained from an image of the biological sample. For example, if the first biometric feature is a face feature and the image of the biological sample is a human photograph, an image detection algorithm may be used to obtain the face of the human photograph and determine the first biometric feature based on the face feature.

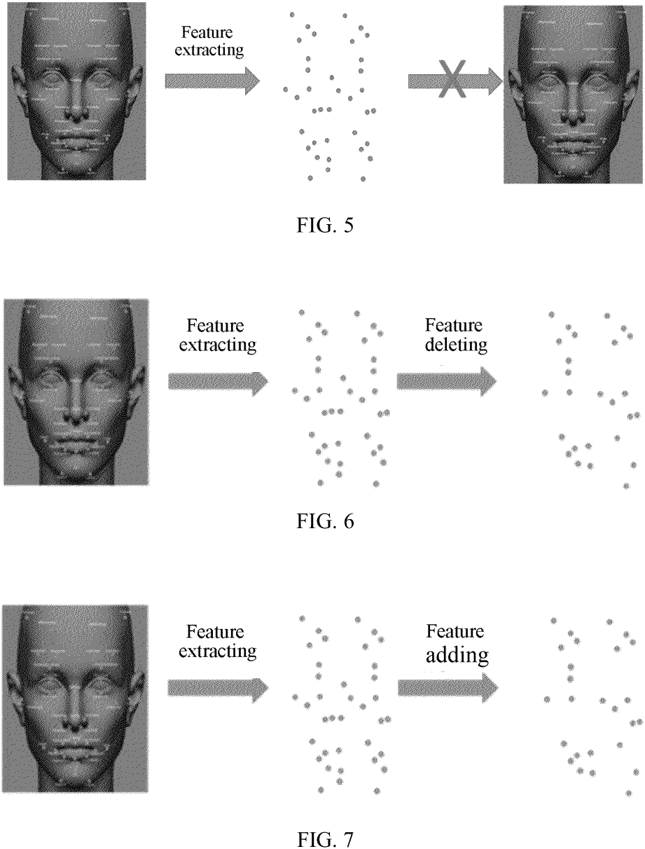

Referring to FIG. 5, performing the privacy-removing process on the first biometric feature of the biological sample may include processing, by using an irreversible algorithm, the first biometric feature. The irreversible algorithm may be an algorithm in which the second biometric feature obtained by inputting the first biometric feature into the irreversible algorithm and processing the first biometric feature by the irreversible algorithm cannot be reverted or restored to the first biometric feature.

Referring to FIG. 6, in an embodiment, performing the privacy-removing process on the first biometric feature of the biological sample may include removing part of feature values in the first biometric feature. For example, the feature vector of the face feature is B1 ={b1, b2, b3, b4}, and after being processed by the irreversible algorithm, the feature values b2 and b4 in the feature vector of the face feature are removed to obtain B2={b1, b3}, so that even if B2 is stolen, B2 cannot be restored or reverted to B1 without being able to obtain the two feature values b2 and b4, thereby ensuring that the use of the first biometric feature is safe.

Referring to FIG. 7, in an embodiment, performing the privacy-removing process on the first biometric feature of the biological sample may include adding a feature value in the feature value of the first biometric feature. For example, the feature vector of the face feature is C1 = {c1, c2, c3, c4}, and after being processed by the predetermined irreversible algorithm, the two feature values d1 and d2 are added in the feature vector of the face feature to obtain C2={c1, d1, c2, c3, d2, c4}, so that even if C2 is stolen, C2 cannot be restored or reverted to C1 without being able to obtain the two feature values d1 and d2, thereby ensuring that the use of the first biometric feature is safe.

In an embodiment, performing the privacy-removing process on the first biometric feature of the biological sample may include changing a feature value in the first biometric feature. For example, the feature vector of the face feature is D1={d1, d2, d3, d4}, and after being processed by the predetermined irreversible algorithm, the first feature value d1 in the face feature vector is changed to e1 and the second feature value d2 is changed to e2 to obtain D2={e1, e2, d3, d4}, so that even if D2 is stolen, D2 cannot be restored or reverted to D1 without being able to obtain which feature value in the feature vector of the face feature is changed, thereby ensuring that the use of the first biometric feature is safe..

Referring to FIG. 8, in an embodiment, the privacy-removing process may be performed on the first biometric feature during the extraction of the first biometric feature. For example, feature data of a face image is extracted, the feature data is pre-processed, a face image feature is obtained using a feature extraction algorithm, and then the privacy-removing process is performed on the face image feature. It shall be noted that the privacy-removing process may be performed before the pre-processing of the feature data or after the pre-processing of the feature data.

In an embodiment, the first biometric feature may be feature data of a biological sample captured by various types of sensors, for example, fingerprint data captured by a fingerprint sensor, audio data captured by an audio collector and image data captured by an image sensor, etc. Here, the sensor may capture the first biometric feature of the biological sample by means of a neural network algorithm.

The first biometric feature is one or more of a face image feature, a fingerprint image feature, a hand image feature, a torso image feature, and a limb image feature.

In an embodiment, after the second biometric feature is obtained at the current end, the registration may be completed at the current end to register the second biometric feature as the biometric sample feature for identity authentication. That is, the acquisition of the first biometric feature, the privacy-removing of the first biometric feature and the registration of the second biometric feature are all carried out at the same end. For example, all the three processes are carried out on the mobile phone.

In an embodiment, the system for registration includes a first end and a second end. After the first end obtains the second biometric feature, the first end sends the second biometric feature to the second end, and the second biometric feature is registered as the biometric sample feature for identity authentication. That is, the acquisition of the first biometric feature and the privacy-removing of the first biometric feature are carried out at the first end. The registration of the second biometric feature as the biometric sample feature for identity authentication is carried out at the second end. The entire registration process is carried out by both the first end and the second end. For example, the first end is a terminal and the second end is a server, where the acquisition of the first biometric feature and the privacy-removing of the first biometric feature are carried out at the terminal, and the registration of the second biometric feature as the biometric sample feature for identity authentication is carried out at the server.

In an embodiment, after the second biometric feature is registered as the biometric sample feature for identity authentication, if the biometric sample to be authenticated passes the subsequent authentication process, the user of the biometric sample to be authenticated may be identified as a valid user and may perform a specific function needing user authentication. Such specific function includes, but is not limited to, payment function, access control function, information access function, information copy transmission function or information modification function. Here, authentication passing may be that the similarity between the biometric sample feature to be authenticated and the biometric sample feature for identity authentication is greater than a set threshold.

In an embodiment of the present disclosure, since the biometric sample feature for identity authentication is the second biometric feature obtained by performing the privacy-removing process on the first biometric feature of the biometric sample, such that even if the second biometric feature is stolen during the registration or after storage, the second biometric feature cannot be restored or reverted to the first biometric feature, which enhances the security of the biometric feature during or after the registration.

FIG. 9 shows a method for registering a biometric feature according to an embodiment, and the method further includes:

step 91, storing the second biometric feature in a local device for identity authentication; or sending the second biometric feature to a remote device for identity authentication to be stored in the remote device.

In an embodiment, after the current end obtains the second biometric feature, the second biometric feature may be stored locally in a device for identity authentication, and is registered locally as a biometric sample feature for identity authentication. That is, the acquisition of the first biometric feature, the privacy-removing process of the first biometric feature and the registration of the second biometric feature are all performed at the local device for identity authentication.

In an embodiment, the system for registration includes a local acquisition device and a remote device for identity authentication. After the local acquisition device obtains the second biometric feature, the local acquisition device sends the second biometric feature to the remote device for identity authentication, and the second biometric feature is registered as the biometric sample feature for identity authentication. That is, the acquisition of the first biometric feature and the privacy-removing process of the first biometric feature are carried out at the local acquisition device. The registration of the second biometric feature as the biometric sample feature for identity authentication is carried out at the remote device for identity authentication. The entire registration process is carried out by both the local acquisition device and the remote device for identity authentication. For example, the local acquisition device is a terminal and the remote device for identity authentication is a server, where the acquisition of the first biometric feature and the privacy-removing of the first biometric feature are carried out at the terminal, and the registration of the second biometric feature as the biometric sample feature for identity authentication is carried out at the server.

In an embodiment, the local first end sends a registration request carrying the second biometric feature to at least one remote device for identity authentication (the second end). The registration request is used to request the at least one remote device for identity authentication to register the second biometric feature as the biometric sample feature.

In an embodiment, the first end may be a terminal and the second end may be a server. For example, the first end is a mobile phone and the second end is an authentication server.

In an embodiment, the registration request carries a feature vector of the second biometric feature. Here, the transmission of the biometric feature is more secure as the second biometric feature is a de-privatized feature.

In an embodiment, the registration request may also carry user information, e.g., a user account. The user information indicates the user for whom the biometric feature registration is to be performed. Further, for example, the user information may also be a user identifier. The user account includes an application account, a payment account, a mobile phone number and/or a social media account. The user identifier may include, for example, an ID number and/or a passport number. Here, the user information may be set by the user.

In an embodiment, the second biometric feature may be divided into a plurality of parts according to a predetermined rule, the plurality of parts are carried respectively in registration requests sent to different second ends, and the registrations of different parts are performed on different devices for identity authentication. In this way, during the subsequent authentication of the biometric feature, different parts of the biometric feature to be authenticated which are divided according to the same predefined rule can also be authenticated at different devices for identity authentication, enhancing authentication security due to the involvement of multiple devices for identity authentication.

In an embodiment, the different parts of the second biometric feature are carried in registration requests sent to different remote devices for identity authentication, and sent to different remote devices for identity authentication.

In an embodiment, after the different parts of the second biometric feature are sent to the different remote devices for identity authentication, the respective remote devices for identity authentication may store the received parts of the second biometric feature respectively.

In an embodiment, the second biometric feature is divided into different parts according to a predetermined rule. For example, a set of feature values of the second biometric feature is divided into a plurality of different subsets having the same number of feature values, and each subset corresponds to one part. For example, if the feature vector of the second biological feature is T={N1, N2, N3, N4, N5, N6, N7, N8}, the feature values of the second biological feature is equally divided, and it obtains four sub-feature vectors T1={N1, N2}, T2={N3, N4}, T3={N5, N6}, T4={N7, N8}, with each sub-feature vector corresponding to one part of the second biometric feature.

Further, for example, the set of feature values of the second biometric feature is divided into a different of subsets having different numbers of feature values, and each subset corresponds to one part. For example, if the feature vector of the second biological feature is T={N1, N2, N3, N4, N5, N6, N7, N8}, the feature values of the second biological feature are unequally divided and it obtains four sub-feature vectors T1={N1}, T2={N2, N3, N4}, T3={N5, N6}, T4={N7, N8}, with each sub-feature vector corresponding to one part of the second biological feature.

There may be no overlap between the features or feature values contained in the various parts of the second biometric feature.

It is important to note that the respective parts of the second biometric feature can be combined to form the described sample feature.

Since the second biometric feature is stored separately at different ends, if an illegal user attacks the feature database where the sample feature is stored to try to steal the sample feature, as different parts of the sample feature are now stored at different ends, it is clear that this would require at least attacking at least each remote device for identity authentication in order to steal the sample feature, which makes it more difficult to hacking into and attack the feature database.

In summary, in the embodiment of the present disclosure, the way in which different parts of the second biological sample are stored in different remote devices for identity authentication enhances the security of biometric feature authentication.

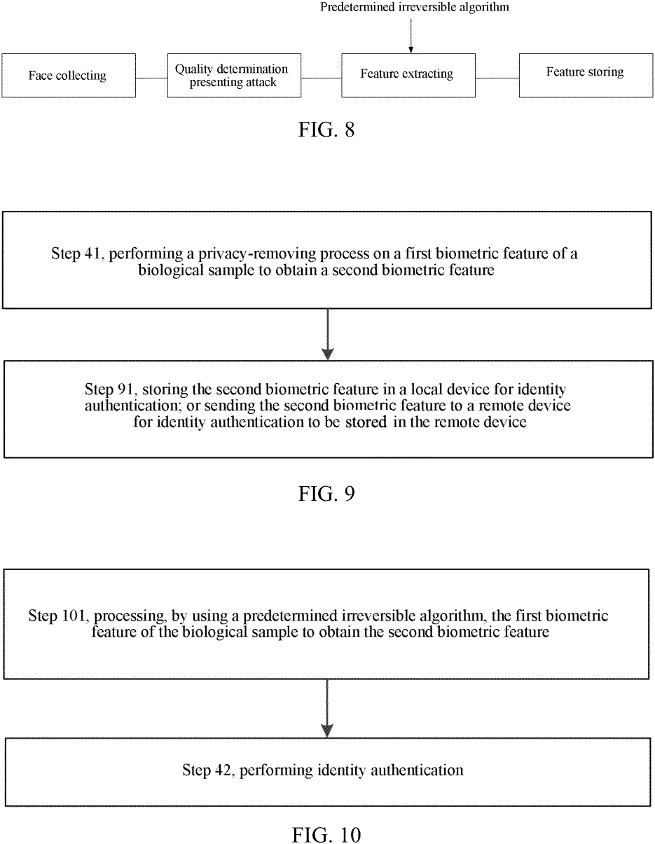

FIG. 10 illustrates a method for registering a biometric feature according to an embodiment. The step 41 of performing the privacy-removing process on the first biometric feature of the biological sample to obtain the second biometric feature includes:

step 101, processing, by using an irreversible algorithm, the first biometric feature of the biological sample to obtain the second biometric feature

The irreversible algorithm herein may include an irreversible encrypting algorithm. For example, the irreversible encrypting algorithm includes, but is not limited to, a Message-Digest Algorithm (MDA).

When the Message-Digest Algorithm is used, the second biometric feature is an encrypted feature obtained by encrypting the first biometric feature through the Message-Digest Algorithm.

In an alternative embodiment, the irreversible algorithm may further include an irreversible feature scrambling algorithm. The irreversible feature scrambling algorithm herein includes, but is not limited to, a redundant feature adding algorithm, a feature deleting algorithm and/or a feature replacing algorithm.

In an embodiment, the first biometric feature is encrypted using an irreversible encrypting algorithm to obtain the second biometric feature. The second biometric feature is not restorable to the first biometric feature.

In an embodiment, the feature vector of the first biometric feature is F1={K1, K2, K3, K4}, and after the feature vector of the first biometric feature is encrypted using the irreversible encrypting algorithm, the second biometric feature is obtained as F2={KM1, KM2, KM3, KM4}. Here, F2 cannot be reverted or restored to F1.

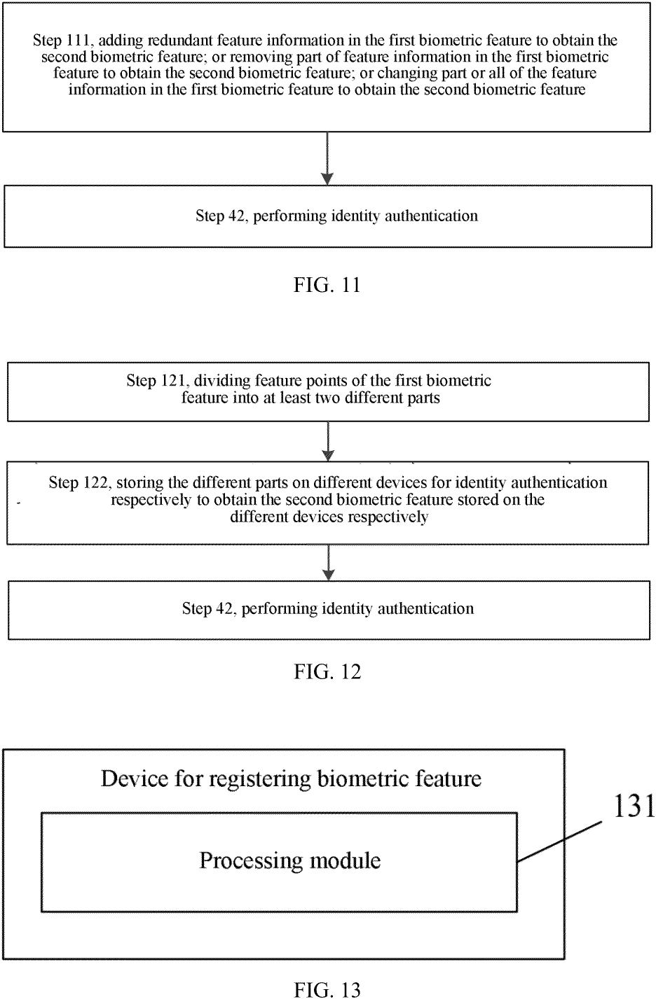

FIG. 11 shows a method for registering a biometric feature according to an embodiment. The step 41 of performing the privacy-removing process on the first biometric feature of the biological sample to obtain the second biometric feature includes:

step 111, adding redundant feature information in the first biometric feature to obtain the second biometric feature; or removing part of feature information in the first biometric feature to obtain the second biometric feature; or changing part or all of the feature information in the first biometric feature to obtain the second biometric feature.

In an embodiment, a feature point is added in the first biometric feature to obtain the second biometric feature. For example, refer to FIG. 7 again, the first biometric feature includes N feature points, and T feature points may be added in the N feature points to obtain the second biometric feature that includes (N+T) feature points.

In an embodiment, the face feature includes 2 feature points and the feature vector of the face feature is C1={c1, c2, c3, c4}. After adding a feature point to the face feature, the two feature values d1 and d2 are added to the feature vector of the face feature to obtain C2={c1, d1, c2, c3, d2, c4}, so that even if C2 is stolen, C2 cannot be restored or reverted to C1 without being able to obtain the two feature values d1 and d2, thereby ensuring that the use of the first biometric feature is safe.

In an embodiment, part of the feature points in the first biometric feature are removed to obtain the second biometric feature. Referring to FIG. 6 again, the first biometric feature includes N feature points, and T feature points may be removed from the N feature points to obtain the second biometric feature including (N-T) feature points.

In an embodiment, the face feature includes 2 feature points and the feature vector of the face feature is C1={c1, c2, c3, c4}. After removing one feature point from the face feature, the two feature values c1 and c2 are removed from the feature vector of the face feature to obtain C2={c3, c4}, so that even if C2 is stolen, C2 cannot be restored or reverted to C1 without being able to obtain the two feature values c1 and c2, thereby ensuring that the use of the first biometric feature is safe.

In an embodiment, the second biometric feature is obtained by changing part or all of the feature points in the first biometric feature.

For example, the face feature includes 2 feature points and the feature vector of the face feature is D1={d1, d2, d3, d4}. By changing one feature point of the face feature, the first feature value d1 in the face feature vector is changed into e1 and the second feature value d2 is changed into e2 to obtain D2={e1, e2, d3, d4}, so that even if D2 is stolen, D2 cannot be restored or reverted to D1 without being able to know which feature value in the feature vector of the face feature is changed, thereby ensuring that the use of the first biometric feature is safe.

FIG. 12 shows a method for registering a biometric registration according to an embodiment. The step 41 of performing the privacy-removing process on the first biometric feature of the biological sample to obtain the second biometric feature includes:

step 121, dividing feature points of the first biometric feature into at least two different parts.

In an embodiment, the feature points of the first biometric feature includes a feature point 1, a feature point 2, a feature point 3, a feature point 4 and a feature point 5. The feature points are divided into two parts, the first part includes the feature point 1, feature point 2 and feature point 3, and the second part includes the feature point 4 and feature point 5.

The method further includes step 122 of storing the different parts on different devices for identity authentication respectively to obtain the second biometric feature stored on the different devices for identity authentication respectively.

In an embodiment, the first part is stored on a terminal and the second part is stored on a device for identity authentication. Here, the device for identity authentication may be an authentication server.

FIG. 13 shows a device for registering a biometric feature according to an embodiment. The device includes a processing module 131.

The processing module 131 is configured to perform a privacy-removing process on a first biometric feature of a biological sample to obtain a second biometric feature.

The second biometric feature is a biological sample feature for identity authentication.

With respect to the device in the above embodiment, the processing module 131 is also configured to perform the method of any of the above embodiments, and the specific manner in which the processing module 131 performs the operation has been described in detail in the embodiment relating to the method and will not be described in detail here.

An embodiment of the present disclosure provides a communication device, including:
a processor; and
a memory for storing executable instructions of the processor,
wherein the processor is configured to implement the method according to any embodiment of the present disclosure when running the executable instructions.

The processor may include various types of storage media that are non-transitory computer storage media that are capable of continuing to store information after the communication device has been powered down.

The processor may be connected to the memory via a bus, for example, for reading executable programs stored on the memory.

An embodiment of the present disclosure provides a computer storage medium having a computer executable program stored thereon that, when being executed by the processor, implements the method according to any embodiment of the present disclosure.

With regard to the device in the above-mentioned embodiment, the specific manner in which the respective modules perform their operations has been described in detail in the embodiment concerning the method and will not be described in detail here.

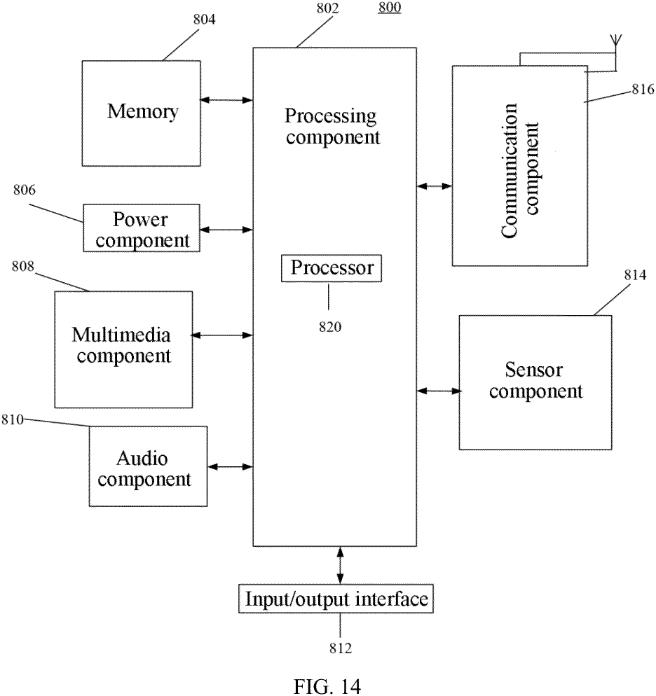

FIG. 14 is a block diagram of a user device (UE) 800 according to an embodiment. For example, the user device 800 may be a mobile phone, a computer, a digital broadcasting user device, a messaging device, a game console, a tablet device, a medical device, a fitness device, a personal digital assistant, or the like.

Referring to FIG. 14, the user device 800 may include one or more of a processing component 802, a memory 804, a power component 806, a multimedia component 808, an audio component 810, an input/output (I/O) interface 812, a sensor component 814, and a communication component 816.

The processing component 802 generally controls the overall operations of the user device 800, such as operations associated with display, telephone calls, data communications, camera operations, and recording operations. The processing component 802 may include one or more processors 820 to execute instructions to complete all or part of the steps of the foregoing method. In addition, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support the operation at the user device 800. Examples of these data include instructions for any application or method operating on the user device 800, contact data, phone book data, messages, pictures, videos and the like. The memory 804 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 806 provides power to various components of the user device 800. The power component 806 may include a power management system, one or more power supplies, and other components associated with generating, managing, and distributing power for the user device 800.

The multimedia component 808 includes a screen that provides an output interface between the user device 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 808 includes a front camera and/or a rear camera. When the user device 800 is in an operation mode, such as a shooting mode or a video mode, the front camera and/or the rear camera can receive external multimedia data. Each front camera and rear camera may be a fixed optical lens system or have focal length and optical zoom capabilities.

The audio component 810 is configured to output and/or input audio signals. For example, the audio component 810 includes a microphone (MIC), and when the user device 800 is in an operation mode, such as a call mode, a recording mode, and a voice recognition mode, the microphone is configured to receive an external audio signal. The received audio signal can be further stored in the memory 804 or sent via the communication component 816. In some embodiments, the audio component 810 further includes a speaker for outputting audio signals.

The I/O interface 812 provides an interface between the processing component 802 and a peripheral interface module. The above-mentioned peripheral interface module may be a keyboard, a click wheel, a button, and the like. These buttons may include but are not limited to home button, volume button, start button, and lock button.

The sensor component 814 includes one or more sensors for providing the terminal 800 with various aspects of state evaluation. For example, the sensor component 814 can detect the on/off status of the user device 800 and the relative positioning of components. For example, the component is a display and keypad of the user device 800. The sensor component 814 can also detect the position change of the user device 1 800 or a component of the user device 800, the presence or absence of contact between the user and the user device 800, the orientation or acceleration/deceleration of the user device 800, and the temperature change of the user device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the user device 800 and other devices. The user device 800 can access a wireless network based on a communication standard, such as WiFi, 2G, or 3G, or a combination thereof. In an embodiment, the communication component 816 receives a broadcast signal or broadcast related information from an external broadcast management system via a broadcast channel. In an embodiment, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the user device 800 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 804 including instructions, and the instructions may be executed by the processor 820 of the user device 800 to complete the foregoing method. For example, the non-transitory computer-readable storage medium may be ROM, random access memory (RAM), CD-ROM, magnetic tape, floppy disk, optical data storage device and the like.

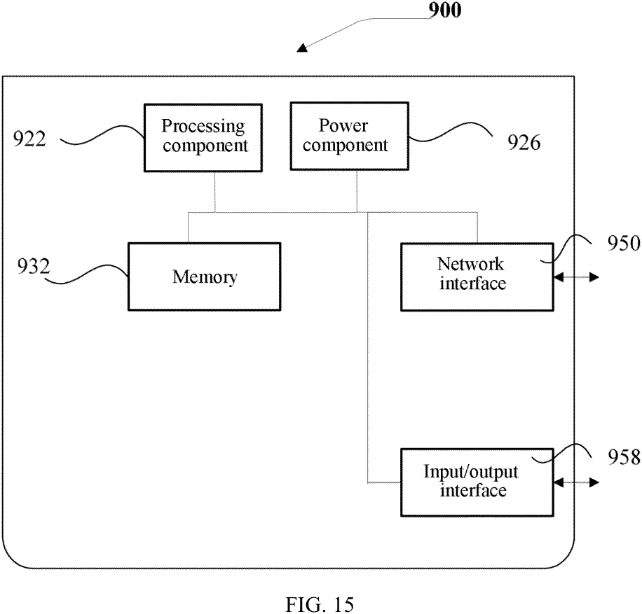

As shown in FIG. 15, an embodiment of the present disclosure provides a structure of a base station. For example, the base station 900 may be provided as a device at the network side. Referring to FIG. 15, the base station 900 includes a processing component 922 which further includes one or more processors, and a memory resource which is represented by a memory 932 and is configured for storing instructions such as application programs executable by the processing component 922. The application program stored in the memory 932 may include one or more modules each corresponding to a set of instructions. Furthermore, the processing component 922 is configured to execute instructions to perform any one of the above methods applied in the base station, for example, the method shown in FIGS. 2 to 6.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in memory 932, such as Windows Server™, Mac OS X™, Unix™, Linux™, Free BSD™ or the like.

Those skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only, with the true scope and spirit of the present disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

In some embodiments, a method is provided for registering a biometric feature, including:
performing a privacy-removing process on a first biometric feature of a biological sample to obtain a second biometric feature,
where the second biometric feature is a biological sample feature for identity authentication.

In some embodiments, the method above further includes:
storing the second biometric feature in a local device for identity authentication; or
sending the second biometric feature to a remote device for identity authentication to be stored in the remote device.

In some embodiments, performing the privacy-removing process on the first biometric feature of the biological sample to obtain the second biometric feature may include:

processing, by using an irreversible algorithm, the first biometric feature of the biological sample to obtain the second biometric feature.

In some embodiments, processing, by using the irreversible algorithm, the first biometric feature of the biological sample to obtain the second biometric feature may include:
encrypting, by using the irreversible encrypting algorithm, the first biometric feature to obtain the second biometric feature,
where the second biometric feature is not restorable to the first biometric feature.

In some embodiments, performing the privacy-removing process on the first biometric feature of the biological sample to obtain the second biometric feature may include:
adding redundant feature information in the first biometric feature to obtain the second biometric feature; or
removing part of feature information in the first biometric feature to obtain the second biometric feature; or
changing part or all of the feature information in the first biometric feature to obtain the second biometric feature.

In some embodiments, adding redundant feature information in the first biometric feature to obtain the second biometric feature may include:

adding a feature point in the first biometric feature to obtain the second biometric feature.

In some embodiments, removing part of the feature information in the first biometric feature to obtain the second biometric feature may include:

removing part of feature points in the first biometric feature to obtain the second biometric feature.

In some embodiments, changing part or all of the feature information in the first biometric feature to obtain the second biometric feature may include:

changing part or all of feature points in the first biometric feature to obtain the second biometric feature.

In some embodiments, performing the privacy-removing process on the first biometric feature of the biological sample to obtain the second biometric feature may include:
dividing feature points of the first biometric feature into at least two different parts; and
storing the different parts on different devices for identity authentication respectively to obtain the second biometric feature stored on the different devices for identity authentication.

In some embodiments, the first biometric feature may include one or more of a face image feature, a fingerprint image feature, a hand image feature, a torso image feature, and a limb image feature.

In some embodiments, a device is provided for registering a biometric feature, including a processing module,
where the processing module is configured to perform a privacy-removing process on a first biometric feature of a biological sample to obtain a second biometric feature, and
where the second biometric feature is a biological sample feature for identity authentication.

In some embodiments, a user device is provided. The device may include:
a processor; and
a memory for storing executable instructions of the processor,
where the processor is configured to implement the methods above when running the executable instructions.

In some embodiments, a computer storage medium having a computer executable program stored thereon that, when being executed by the processor, implements the methods above.

1. A method for registering a biometric feature, comprising:
performing a privacy-removing process on a first biometric feature of a biological sample to obtain a second biometric feature,
wherein the second biometric feature is a biological sample feature for identity authentication.

2. The method according to claim 1, further comprising:
storing the second biometric feature in a local device for identity authentication; or
sending the second biometric feature to a remote device for identity authentication to be stored in the remote device.

3. The method according to claim 1, wherein performing the privacy-removing process on the first biometric feature of the biological sample to obtain the second biometric feature comprises:
processing, by using an irreversible algorithm, the first biometric feature of the biological sample to obtain the second biometric feature.

4. The method according to claim 3, wherein processing, by using the irreversible algorithm, the first biometric feature of the biological sample to obtain the second biometric feature comprises:
encrypting, by using the irreversible encrypting algorithm, the first biometric feature to obtain the second biometric feature,
wherein the second biometric feature is not restorable to the first biometric feature.

5. The method according to claim to 1, wherein performing the privacy-removing process on the first biometric feature of the biological sample to obtain the second biometric feature comprises:
adding redundant feature information in the first biometric feature to obtain the second biometric feature; or
removing part of feature information in the first biometric feature to obtain the second biometric feature; or
changing part or all of the feature information in the first biometric feature to obtain the second biometric feature.

6. The method according to claim 5, wherein adding the redundant feature information in the first biometric feature to obtain the second biometric feature comprises:
adding a feature point in the first biometric feature to obtain the second biometric feature.

7. The method according to claim 5, wherein removing part of the feature information in the first biometric feature to obtain the second biometric feature comprises:
removing part of feature points in the first biometric feature to obtain the second biometric feature.

8. The method according to claim 5, wherein changing part or all of the feature information in the first biometric feature to obtain the second biometric feature comprises:
changing part or all of feature points in the first biometric feature to obtain the second biometric feature.

9. The method according to claim 1, wherein performing the privacy-removing process on the first biometric feature of the biological sample to obtain the second biometric feature comprises:
dividing feature points of the first biometric feature into at least two different parts; and
storing the different parts on different devices for identity authentication respectively to obtain the second biometric feature stored on the different devices for identity authentication.

10. The method according to claim 1, wherein the first biometric feature is at least one of following features: a face image feature, a fingerprint image feature, a hand image feature, a torso image feature, or a limb image feature.

11. (canceled)

12. A device for registering a biometric feature, comprising:
a processor; and
a memory for storing executable instructions of the processor,
wherein when running the executable instructions, the processor is configured to implement acts comprising:
performing a privacy-removing process on a first biometric feature of a biological sample to obtain a second biometric feature,
wherein the second biometric feature is a biological sample feature for identity authentication.

13. A non-transitory computer storage medium having a computer executable program stored thereon that, when being executed by the processor, implements acts comprising:
performing a privacy-removing process on a first biometric feature of a biological sample to obtain a second biometric feature,
wherein the second biometric feature is a biological sample feature for identity authentication.

14. The device according to claim 12, wherein the processor is configured to implement acts further comprising:
storing the second biometric feature in a local device for identity authentication; or
sending the second biometric feature to a remote device for identity authentication to be stored in the remote device.

15. The device according to claim 12, wherein performing the privacy-removing process on the first biometric feature of the biological sample to obtain the second biometric feature comprises:
processing, by using an irreversible algorithm, the first biometric feature of the biological sample to obtain the second biometric feature.

16. The device according to claim 15, wherein the processing, by using the irreversible algorithm, the first biometric feature of the biological sample to obtain the second biometric feature comprises:
encrypting, by using an irreversible encrypting algorithm, the first biometric feature to obtain the second biometric feature,
wherein the second biometric feature is not restorable to the first biometric feature.

17. The device according to claim to 12, wherein the performing the privacy-removing process on the first biometric feature of the biological sample to obtain the second biometric feature comprises:
adding redundant feature information in the first biometric feature to obtain the second biometric feature; or
removing part of feature information in the first biometric feature to obtain the second biometric feature; or
changing part or all of the feature information in the first biometric feature to obtain the second biometric feature.

18. The device according to claim 17, wherein the adding redundant feature information in the first biometric feature to obtain the second biometric feature comprises:
adding a feature point in the first biometric feature to obtain the second biometric feature.

19. The device according to claim 17, wherein the removing part of the feature information in the first biometric feature to obtain the second biometric feature comprises:
removing part of feature points in the first biometric feature to obtain the second biometric feature.

20. The device according to claim 17, wherein the changing part or all of the feature information in the first biometric feature to obtain the second biometric feature comprises:
changing part or all of feature points in the first biometric feature to obtain the second biometric feature.

21. The device according to claim 12, wherein the performing the privacy-removing process on the first biometric feature of the biological sample to obtain the second biometric feature comprises:
dividing feature points of the first biometric feature into at least two different parts; and
storing the different parts on different devices for identity authentication respectively to obtain the second biometric feature stored on the different devices for identity authentication.
